(19) United States
(12) Patent Application Publication
(10) Pub. No.: US 2009/0201835 A1
(43) Pub. Date: Aug. 13, 2009

(54) METHOD FOR SUPPORTING A MULTI-PARTY CALL IN COMBINATIONAL SESSION

(75) Inventors: KARTHIK BALAKRISHNAN, Grayslake, IL (US); Ganesan Rengaraju, Oak Park, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA INC, LIBERTYVILLE, IL (US)

(21) Appl. No.: 12/027,406

(22) Filed: Feb. 7, 2008

(51) Int. Cl. H04L 12/16

(52) U.S. Cl. 370/261; 370/352

(57) ABSTRACT

There is provided a method of a first mobile communication device for supporting a combinational circuit switched and packet switched session with other communication devices. During a combination session (100) between first and second mobile communication devices (110, 120), the first mobile communication device may forward or duplicate data to a third mobile communication device (210) without intervention from a remote server. There is also provided a method for supporting supplementary services in a combinational circuit switched and packet switched session between three or more mobile communication devices (110, 120, 210). Data is communicated between first and second mobile communication devices (110, 120) via a packet switched data session (140) while maintaining a circuit switched call session (130) between the first and second mobile communication devices. A multi-party conference call which includes the first and second mobile communication devices (110, 120) and one or more other mobile communication devices (210) is then established via the circuit switched call session (130, 220) while maintaining the packet switched data session (140) between the first and second mobile communication devices (110, 120).

### FIELD OF THE INVENTION

The present invention relates generally to the field of combinational sessions of voice calls and data communications. In particular, the invention relates to a system and method of a mobile communication device for providing data to one or more other mobile communication device during a combinational session.

### BACKGROUND OF THE INVENTION

Combinational session refers to a combination of voice calls on Circuit Switch (CS) domain networks and data communication on Packet Switch (PS) domain networks. An example of a combinational session is CSI, which is a circuit switch domain network with an IP Multimedia Subsystem (IMS) call. Rich Voice Call is a service in which a voice call is on a CS domain and a data communication is on a PS domain. For two parties engaged in a voice call, either party may initiate a one-way transfer of data, such as video data, as an originator.

Devices engaged in a CS call session may provide the ability of supporting supplementary services such as place a call on hold/wait; initiate a new call, call switching, and conference call. A call processing server provides the ability to support the supplementary services. In particular, control signals are exchanged between devices and the call processing server, and the call processing server assigns the necessary traffic channel for media transport and manages the session control.

Existing video share concepts focus primarily on peer-to-peer communication, and the supplementary services are disabled. Users engaged in a video share call need to terminate the video calling session if they want to use supplementary services. Also, current standards or protocols do not provide any type of mechanism to support a multiparty call in CSI session. With the evolution of video share for IMS services, support for user experiences similar to what we experience in CS voice calls will be important.

Thus, there is a need for a mechanism by which we can extend video share features so that they may be supported in multiparty calls of combinational session without intervention for, i.e., without the need for, a remote server. The video share feature should be available to video-enabled mobile handsets without affecting other participants in a multiparty call.

### BRIEF DESCRIPTION OF THE DRAWINGS

FIG. 1 illustrates an example embodiment of two devices communicating a voice call concurrently with a video share session.

FIG. 2 illustrates the example embodiment of FIG. 2 where a third device communicates with one of the two original devices.

FIG. 3 illustrates the example of embodiment of FIG. 3 where the third device communicates a voice call and video share session with one of the two original devices.

FIG. 4 is a block diagram illustrating an example configuration for one or more of the devices shown in FIGS. 1, 2 and 3.

FIG. 5 is a timing diagram illustrating initial conditions between devices A and B and three scenarios involving devices C or D, which may follow the initial conditions.

### DETAILED DESCRIPTION OF THE EMBODIMENTS

There is described herein a system and method for generating similar real-time transport protocol streams and sending them to multiple mobile communication devices in a combinational session, which includes circuit switched communication and packet switched communication. The communication network supporting the mobile devices, such as an IP Multimedia Subsystem (IMS) network, has the flexibility to support signaling for multiple, concurrent Multiparty Packet Switch (PS) sessions in the mobile devices. Thus, the system and method provides enhanced experiences for the users of the mobile devices by supporting multiple IP-based sessions in the communication network.

The system and method also has the capability of working in conjunction with existing implementations of video share services deployed widely by various operators of communication networks, such as existing IMS infrastructures and existing mobile device, to achieve interoperability. A mobile device, in accordance with the present invention, is capable of supporting multiple IP-based sessions in a communication network as other participants in a CS multiparty call may be unaware of the fact that the mobile device is operating a simultaneous video share feature with the other participant in the same multiparty call.

The system and method is applicable to combinational sessions that apply one way file transfer techniques, such as half-duplex video. The system and method does not require a server to support supplementary services in a combinational session, such as call waiting, call hold, new call, call switch and conference call. Also, the user-experience for the system and method is substantially similar to that of supplementary services in conventional voice calls.

One aspect of the present invention is a method of a first mobile communication device for supporting a combinational circuit switched and packet switched session with other communication devices. The first mobile communication device receives data from a second mobile communication device. The first mobile communication device then forwards the received data to a third mobile communication device during the combinational session without intervention from a remote server.

Another aspect of the present invention is a method of a first mobile communication device for duplicating data instead of forwarding received data. The first mobile communication device produces the second data based on first data so that the first and second data are similar. For example, the first data may be duplicated so that the first and second data are identical. The first mobile communication device transmits the first data to the second mobile communication device and the second data to the third mobile communication device during the combinational session without intervention from a remote server.

Yet another aspect of the present invention is a method for supporting supplementary services in a combinational circuit switched and packet switched session between three or more mobile communication devices. Data is communicated between first and second mobile communication devices via a packet switched data session while maintaining a circuit switched call session between the first and second mobile communication devices. The first mobile communication device transmits the data to the second mobile communication device or vice-versa. Next, communication is initiated between the first mobile communication device and a third mobile communication device via the circuit switched call session. Either the first mobile communication device or the third mobile communication device may initiate the communication. A multi-party conference call among the first, second and third mobile communication devices is then established via the circuit switched call session while maintaining the packet switched data session between the first and second mobile communication devices.

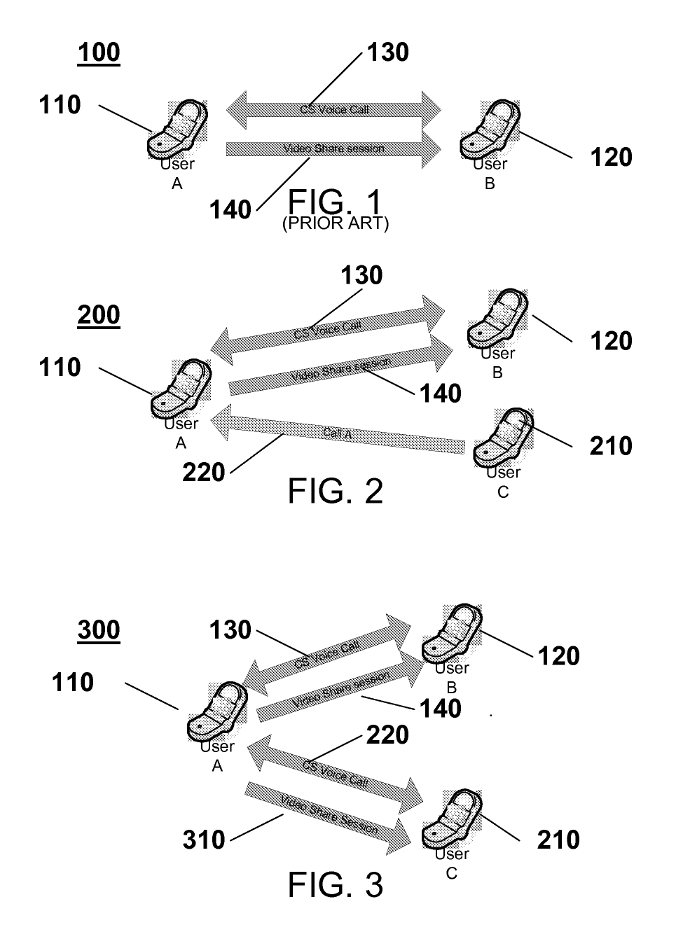

Referring to FIG. 1, a combinational session 100 is a combination of voice calls on Circuit Switch (CS) domain networks and data communication, such as a video share session, on Packet Switch (PS) domain networks. An example of a combinational session is CSI, which is a circuit switch domain network with an IP Multimedia Subsystem (IMS) call. FIG. 1 illustrates an example of two devices 110, 120 communicating a voice call 130 concurrently with a data communication session 140, such as a half-duplex video data transmission.

Referring to FIG. 2, there is illustrated an example 200 of a third device 210 attempting to communicate with one of the two original devices 110, 120. When a subscriber of a mobile communication device 110 who is participating in a first CS call 130 initiates or receives a second CS call 220, the mobile communication device of the subscriber may link the two CS calls together to form a multi-party conference call. If the subscriber of the mobile communication device 110 was participating a combinational session 100 that includes the first CS call 130 (as shown in FIG. 1) before initiating or receiving the second CS call 220, several different scenarios may occur.

For one scenario, the data communication 140 associated with the first CS call 130 of the combinational session 100 may be dropped, and no data communication session is established for the second CS call 220. This is a regular conference call scenario with no data exchange over the data communication of the PS domain network.

For another scenario, the data communication 140 associated with the first CS call 130 may be retained, and no data communication is established with the second CS call 220. For one embodiment, as shown in FIG. 2, User A 110 may be transmitting data 140 to User B 120 concurrently during the first CS call 130 when User C 210 initiates a second CS call 220 with User A (as represented by FIG. 2). In such case, User A 110 may continue to transmit data 140 to User B 120, and User C 210 may only hear audio in the conference call and data is not exchanged with between Users A and C. For another embodiment, User A 110 may be transmitting data 140 to User B 120 concurrently during the first CS call 130 when User A initiates a second CS call 220 with User C 210. User A 110 may continue to transmit data 140 to User B 120, and User C 210 may only hear audio in the conference call and data is not exchanged with between Users A and C. For yet another embodiment, User A 110 may be receiving data 140 from User B 120 concurrently during the first CS call 130 when User C 210 initiates a second CS call 220 with User A. User A 110 may continue to receive data 140 from User B 120, and User C 210 may only hear audio in the conference call and data is not exchanged with between Users A and C. For still another embodiment, User A 110 may be receiving data 140 from User B 120 concurrently during the first CS call 130 when User A initiates a second CS 220 call with User C 210. User A 110 may continue to receive data 140 from User B 120, and User C 210 may only hear audio in the conference call and data is not exchanged with between Users A and C.

For a third scenario, the data communication 140 associated with the first CS call 130 is dropped, and a new data communication (not shown) is established with the participants 110, 210 of the second CS call 220. For this scenario, data exchange takes place with the participants 110, 210 of the second CS call 220, and only audio conversation takes place with the participants 110, 120 of the first CS call 130.

Referring to FIG. 3, there is provided an example 300 of a fourth scenario in which the third device 210 communicates a voice call 220 and data communication 310, such as a video share session, with one of the two original devices 110. When the subscriber of a mobile communication device 110 is participating a combinational session 100 that includes the first CS call 130 before initiating or receiving the second CS call 220, data communications 140, 310 may be maintained for more than two wireless communication devices. In particular, a first stream of data communication 140 associated with the first CS call 130 is maintained, and a second stream of data communication 310 associated with the second CS call 220 may be created.

There are two sub-options for this fourth scenario, which are illustrated by the following examples. If User A 110 of the first CS call 130 was actively engaged in transmitting data via a first data session 140 to User B 120 of the first CS call, then when the second data session 310 is established, User A may start to transmit the data to User C 210 in the second CS call 220 while continuing to transmit the data to the User B of the first CS call (as represented by FIG. 3). User A 110 is thus transmitting data 140, 310 to two participants 120, 210, associated with two different CS calls 130, 220, simultaneously. If, on the other hand, User A 110 in the first CS call 130 was actively receiving data from User B 120 of the first CS call, then when the second data communication 310 is established, User A forwards the data received from User B of the first CS call to User C 210 in the second CS call 220. This principle of forwarding may be applied in a chain resulting in a series of participants who are sharing data from a single transmitter.

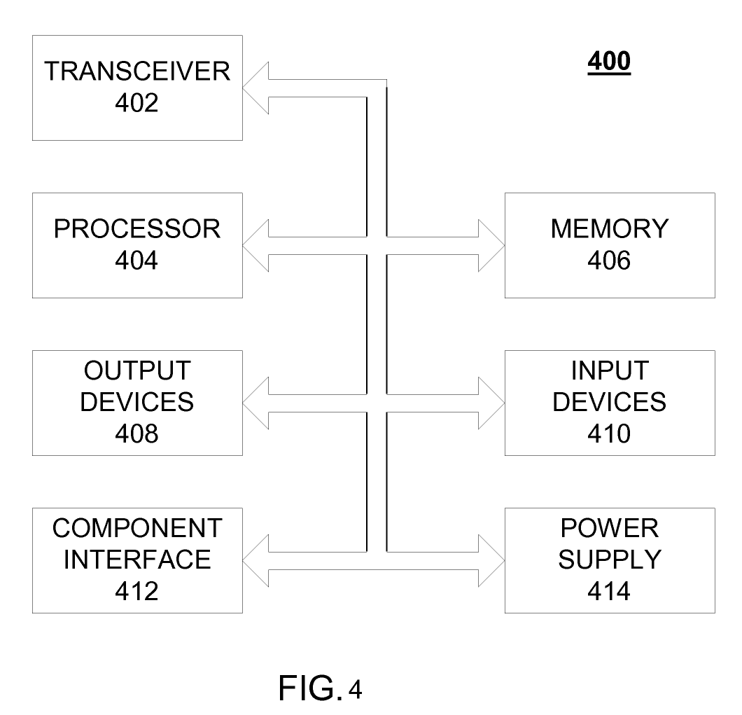

Referring to FIG. 4, there is provided a block diagram illustrating examples of internal components 400 of the wireless communication devices 110, 120, 210 in accordance with the present invention. The internal components 400 may include one or more wired or wireless transceivers 402, one or more processors 404, a memory portion 406, one or more output devices 408, and one or more input devices 410. For example, each embodiment may include a user interface that comprises one or more output devices 408 and one or more input device 410. Also, each transceiver 402 may be directly wired to another component or utilize wireless technology for communication, such as, but are not limited to, cellular-based communications such as analog communications (using AMPS), digital communications (using CDMA, TDMA, GSM, iDEN, GPRS, or EDGE), and next generation communications (using UMTS, WCDMA, LTE or IEEE 802.16) and their variants; a peer-to-peer or ad hoc communications such as HomeRF, Bluetooth and IEEE 802.11(a, b, g or n); and other forms of wireless communication such as infrared technology. In addition, each transceiver 402 may be a receiver, a transmitter or both.

The internal components 400 may further include a component interface 412 to provide a direct connection to auxiliary components or accessories for additional or enhanced functionality and/or a power source 414, such as a power supply or portable battery, for providing power to the other internal components.

The input and output devices 408, 410 of the internal components 400 may include a variety of video, audio and/or mechanical outputs. For example, the output device(s) 408 may include a video output device such as a cathode ray tube, liquid crystal display, plasma display, incandescent light, fluorescent light, front or rear projection display, and light emitting diode indicator. Other examples of output devices 408 include an audio output device such as a speaker, alarm and/or buzzer, and/or a mechanical output device such as a vibrating, motion-based, or animatronics mechanism. Likewise, by example, the input devices 410 may include a video input device such as an optical sensor (for example, a camera), an audio input device such as a microphone, and a mechanical input device such as button or key selection sensors, touch pad sensor, touch screen sensor, capacitive sensor, motion sensor, and switch.

The memory portion 406 of the internal components 400 may be used by the processor 404 to store and retrieve data. The data that may be stored by the memory portion 406 include, but is not limited to, operating systems, applications, and data. Each operating system includes executable code that controls basic functions of the wireless communication devices, such as interaction among the components of the internal components 400, communication with external devices via each transceiver 402 and/or the component interface 412, and storage and retrieval of applications and data to and from the memory portion 406. Each application includes executable code utilizes an operating system to provide more specific functionality for the wireless communication devices. Data is non-executable code or information that may be referenced and/or manipulated by an operating system or application for performing functions of the wireless communication devices.

It is to be understood that FIG. 4 is for illustrative purposes only and is for illustrating components of the wireless communication devices in accordance with the present invention, and is not intended to be a complete schematic diagram of the various components required for the wireless communication devices. Therefore, the wireless communication devices may include various other components not shown in FIG. 4, or may include a combination of two or more components or a division of a particular component into two or more separate components, and still be within the scope of the present invention.

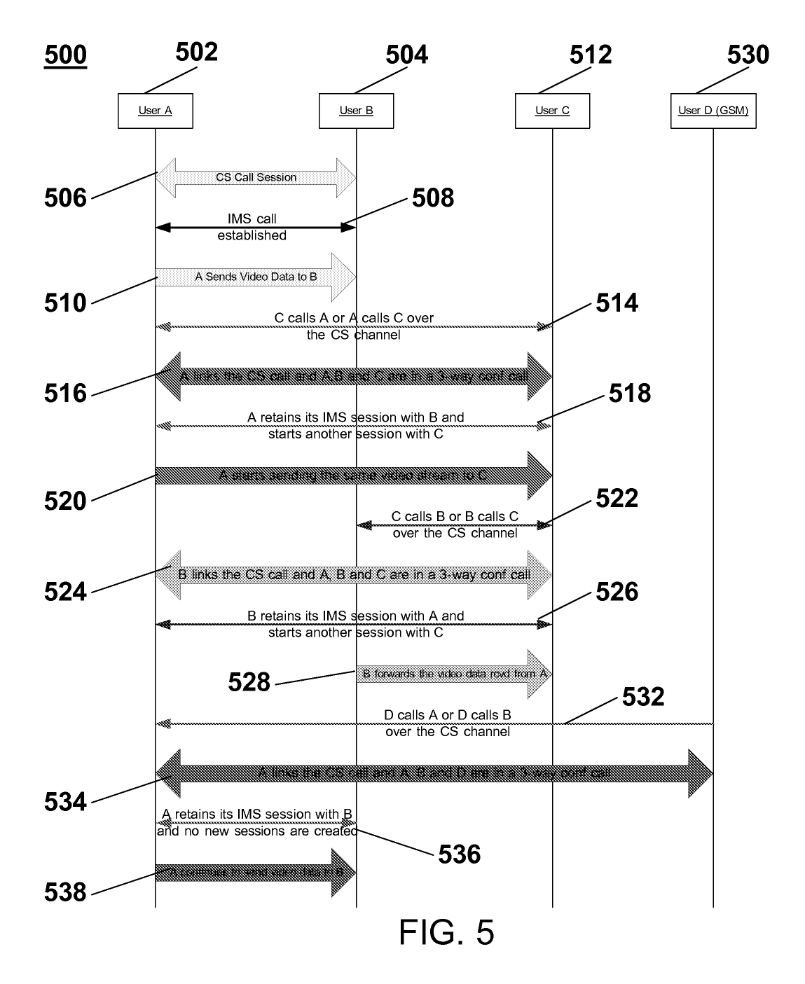

Referring to FIG. 5, there is shown initial conditions between devices A and B and several scenarios involving devices C or D, which may follow the initial conditions. It is to be understood that many different scenarios may apply in accordance with the present invention, and the scenarios described herein are presented as examples. For the initial condition, User A 502 and User B 504 are in a CS call session over a CS domain network, such as a voice call session, concurrently with a data communication session over a PS domain network, such as a video share session. Either the CS call session or the data communication session may be activated first, or they may both be activated simultaneously. For example, the CS call session may be established first, as represented by step 506, and the data communication session (such as an IMS call) may be established thereafter, as represented by step 508. Once the data communication session is established, one device may send data to the other device. For example, the device of User A 502 may send video data over a half-duplex video data transmission to the device of User B 504, as represented by step 510.

After the initial conditions are established, subsequent scenarios may establish communication with one or more third party devices, such as User C 512. The third party device may initiate a call to one of the existing parties, or vice-versa. For this scenario, between the two original devices, the device sending data manages data communication with the third party device(s) during the combination circuit switched plus packet switched session. For example, the device of User C 512 may call the device of User A 502 over a CS channel of the CS domain network (or, in the alternative, the device of User A may call the device of User C) to initiate communication between these devices, as represented by step 514. As a result, the User A device 502 may link the newly formed CS call with the User C device 512 with the existing CS call with the User B device 504 to form a multi-party conference call, as represented by step 516. In addition, the User A device 502 may retain its data communication session with, and continue to send data to, the User B device 504 and start another session with the User C device 512, as represented by step 518. Thereafter, the User A device 502 may start sending the same video stream that it is sending to the User B device 504 to the User C device 512, as represented by step 520.

For one embodiment, the User A device 502 may place the CS call with the User B device 504 on Hold in response to receiving a call from the User C device 512 or initiating a call to the User C device, and the video share session with the User B device would pause in response to being placed on Hold. The User A device 502 may link the CS calls with the User B device 504 and the User C device 512 and, thereby, form a CS multiparty call. In response to forming the multiparty call, the User A device 502 may resume a first video share session over the PS domain network with the User B device 504 and initiated a second video share session over the PS domain network with the User C device 512. Once the User C device 512 accepts the video share invitation from the User A device 502, the User A device may now start streaming to both the User B device 504 and the User C device.

Another scenario that may be applied after the initial conditions are established is represented by steps 522 through 528. Similar to the previous scenario, the third party device may initiate a call to one of the existing parties, or vice-versa. For this scenario, however, the device receiving data manages data communication with the third party device(s) during the combination circuit switched plus packet switched session. For example, the device of User C 512 may call the device of User A 502 over a CS channel of the CS domain network (or, in the alternative, the device of User A may call the device of User C) to initiate communication between these devices, as represented by step 522. As a result, the User A device 502 may link the newly formed CS call with the User C device 512 with the existing CS call with the User B device 504 to form a multi-party conference call, as represented by step 524. In addition, the User A device 502 may retain its data communication session with, and continue to receive data from, the User B device 504 and start another session with the User C device 512, as represented by step 526. Thereafter, the User A device 502 may start sending the same video stream that it is receiving from the User B device 504 to the User C device 512, as represented by step 528.

For one embodiment, the User A device 502 may place the CS call with the User B device 504 on Hold in response to receiving a call from the User C device 512 or initiating a call to the User C device, and the video share session with the User B device would pause in response to being placed on Hold. The User A device 502 may link the CS calls with the User B device 504 and the User C device 512 and, thereby, form a CS multiparty call. In response to forming the multiparty call, the User A device 502 may resume a first video share session over the PS domain network with the User B device 504 and initiated a second video share session over the PS domain network with the User C device 512. Once the User C device 512 accepts the video share invitation from the User A device 502, the User A device may now start streaming data to the User C device that it is receiving from the User B device 504.

Yet another scenario that may be applied after the initial conditions are established is represented by steps 532 through 538. Similar to the previous scenarios, the third party device may initiate a call to one of the existing parties, or vice-versa. For this scenario, however, the third party device 530 has the capability of participating in a circuit switched call during the combination circuit switched plus packet switched session, but does not have any capability of utilizing the data forwarded by the first mobile communication device during the combination circuit switched plus packet switched session. In such case, the devices capable of utilizing data communications are still able to have a data communication session as well as voice communications with all data capable and data non-capable devices. For example, the device of User D 530 may be a data non-capable device that calls the device of User A 502 over a CS channel of the CS domain network (or, in the alternative, the device of User A may call the device of User D) to initiate communication between these devices, as represented by step 532. As a result, the User A device 502 may link the newly formed CS call with the User D device 530 with the existing CS call with the User B device 504 to form a multi-party conference call, as represented by step 534. In addition, the User A device 502 may retain its data communication session with, and continue to receive data from, the User B device 504, and does not start another session with the User D device 530, as represented by step 536. For example, the User A device 502 may query the User D 530 about its capabilities or the User D device may provide its capabilities (or lack thereof) to the User A device in response to the initiation of communication in step 532 or during the formation of the multi-party conference call in step 534. Thereafter, the User A device 502 may continue to send the video stream to the User B device 504, as represented by step 538.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention. For example, the supplemental services described herein are not restricted to multi-party conference calls, but may also apply to other services such as call hold, call waiting, and the like.

What is claimed is:

1. A method of a first mobile communication device for supporting a combinational session with other communication devices, the combinational session including circuit switched communication and packet switched communication, the method comprising:
receiving data by the first mobile communication device from a second mobile communication device; and
forwarding the data to a third mobile communication device during the combinational session without intervention from a remote server.

2. The method of claim 1, wherein the combinational session includes a circuit switched call session and a packet switched data session existing concurrently between the first and second mobile communication devices.

3. The method of claim 1, wherein the third mobile communication device has the capability of participating in a circuit switched call during the combination circuit switched plus packet switched session, but does not have any capability of utilizing the data forwarded by the first mobile communication device during the combination circuit switched plus packet switched session.

4. The method of claim 1, wherein forwarding data received from the first mobile communication device comprises:
providing a first stream of video data from the second mobile communication device to the first mobile communication device via a first packet switched data session; and
providing a second stream of the video data from the first mobile communication device to the third mobile communication device via a second packet switched data session.

5. The method of claim 1, wherein communication between the first and third mobile communication devices is initiated by the first mobile communication device.

6. The method of claim 1, wherein communication between the first and third mobile communication devices is initiated by the third mobile communication device.

7. The method of claim 1, further comprising:
supporting half-duplex video data transmissions between the first and second mobile communication devices; and
supporting full-duplex audio communication among the first, second and third mobile communication devices.

8. A method of a first mobile communication device for supporting a combinational session with other communication devices, the combinational session including circuit switched communication and packet switched communication, the method comprising:
producing second data based on first data at the first mobile communication device, the first and second data being similar; and
transmitting the first and second data, by the first mobile communication device, to second and third mobile communication devices, respectively, during the combinational session without intervention from a remote server.

9. The method of claim 8, wherein the first and second data are identical.

10. The method of claim 8, wherein the combinational session includes a circuit switched call session and a packet switched data session existing concurrently between the first and second mobile communication devices.

11. The method of claim 8, wherein the third mobile communication device has the capability of participating in a circuit switched call during the combination circuit switched plus packet switched session, but does not have any capability of utilizing the second data transmitted by the first mobile communication device during the combination circuit switched plus packet switched session.

12. The method of claim 8, wherein transmitting first and second data comprises:
providing a first stream of video data from the first mobile communication device to the second mobile communication device via a first packet switched data session; and
providing a second stream of the video data from the first mobile communication device to the third mobile communication device via a second packet switched data session.

13. The method of claim 8, wherein communication between the first and third mobile communication devices is initiated by the first mobile communication device.

14. The method of claim 8, wherein communication between the first and third mobile communication devices is initiated by the third mobile communication device.

15. The method of claim 8, further comprising:
supporting half-duplex video data transmissions between the first and second mobile communication devices; and
supporting full-duplex audio communication among the first, second and third mobile communication devices.

16. A method for supporting supplementary services in a combinational session, the combinational session including circuit switched communication and packet switched communication, between three or more mobile communication devices, the method comprising:
communicating data between first and second mobile communication devices via a packet switched data session while maintaining a circuit switched call session between the first and second mobile communication devices;
initiating communication between the first mobile communication device and a third mobile communication device via the circuit switched call session; and
establishing a multi-party conference call among the first, second and third mobile communication devices via the circuit switched call session while maintaining the packet switched data session between the first and second mobile communication devices.

17. The method of claim 16, further comprising supporting the circuit switched call session and the packet switched data session concurrently between the first and second mobile communication devices.

18. The method of claim 16, wherein the third mobile communication device participates in the multi-party conference call, but does not have any capability of participating in the packet switched data call concurrently with the multi-party conference call.

19. The method of claim 16, wherein communicating data between first and second mobile communication devices via a packet switched data session includes providing a first stream of video data from the first mobile communication device to the second mobile communication device via a first packet switched data session, the method further comprising:
providing a second stream of the video data from the first mobile communication device to the third mobile communication device via a second packet switched data session.

20. The method of claim 16, wherein communicating data between first and second mobile communication devices via a packet switched data session includes providing a first stream of video data from the first mobile communication device to the second mobile communication device via a first packet switched data session, the method further comprising:
providing a second stream of the video data from the second mobile communication device to the third mobile communication device via a second packet switched data session.

21. The method of claim 16, wherein communication between the first and third mobile communication devices is initiated by the first mobile communication device.

22. The method of claim 16, wherein communication between the first and third mobile communication devices is initiated by the third mobile communication device.

23. The method of claim 16, wherein establishing a multi-party conference call includes maintaining communication of the data via the packet switched data session between the first and second mobile communication devices.

24. The method of claim 16, wherein:
communicating data between first and second mobile communication devices via a packet switched data session includes supporting half-duplex video data transmissions between the first and second mobile communication devices; and
establishing a multi-party conference call among the first, second and third mobile communication devices includes supporting full-duplex audio communication among the first, second and third mobile communication devices via the circuit-switched call session.
